(19) United States
(12) Patent Application Publication
(10) Pub. No.: US 2025/0164997 A1
(43) Pub. Date: May 22, 2025

(54) SYSTEM AND METHOD FOR REMOTELY VIEWING AND OPERATING MACHINERY IN HAZARDOUS ENVIRONMENTS

(71) Applicant: Northwest Demolition and Dismantling, Inc., Tigard, OR (US)

(72) Inventor: Brian Dalrymple, Portland, OR (US)

(21) Appl. No.: 18/517,474

(22) Filed: Nov. 22, 2023

(51) Int. Cl. G05D 1/224

(52) U.S. Cl. CPC G05D 1/2247

(57) ABSTRACT

A system and method are provided for remotely controlling machinery operated within an exclusion zone, which is a region within which workers are not permitted due to a hazardous condition within the exclusion zone. The system includes one or more cameras that are fixed to industrial machinery (e.g., excavators and haul trucks) and that acquire a video stream of activities of the machinery. The video stream is transmitted to a control station via a series of wireless links to allow the control station to be outside of the exclusion zone and possibly outside a line of sight from the machinery. Repeaters can connect the wireless links with transmit and receive radios operating at different frequencies to enable simultaneous transmission and reception without co-channel interference.

### BACKGROUND

Various situations occur in which an environment is deemed unsafe for workers, and yet work needs to be performed in said environment. One example of such hazardous work is the removal of unexploded ordinance (UXO).

Millions of acres of property in the United States contain UXO, most of which is a result of weapons system testing and troop training activities conducted by the Department of Defense. This property includes active military, formerly used defense, and base realignment and closure sites. Significant risks can be posed by properties containing UXO, depending on the types and amount of UXO present and how the properties are used.

Once UXO has been identified, it can be removed using excavation technologies. Mechanized UXO excavation systems include the use of excavators, bulldozers, front-end loaders, and other heavy construction equipment. For example, backhoe-type excavators are commonly used mechanized systems. For large munitions, an exclusion or safety zone is instituted to keep workers safe during excavation. The size of the exclusion zone can depend on the explosive weight of the item being investigated, requiring remotely controlled excavation.

Remote-controlled UXO excavation systems include telerobotic and autonomous systems. In general, the capabilities and effectiveness of remote-controlled systems are the same as for mechanized systems. The primary difference is that the operator of a remote-controlled system remains outside the immediate hazard area.

Other examples of environments requiring remotely controlled machines can include construction sites that are contaminated with pollution or radiation. Additionally, work safety can be at risk when other man-made or environmental conditions exist that present significant risks to health and human life. For example, repairing a damaged nuclear reactor or operating in a theater of war would be situations in which remotely controlled machines and workers can be advantageous.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic diagram of a wireless system for wireless transmission of a video stream of remotely controlled machinery, in accordance with certain embodiments of the disclosure.

FIG. 2 illustrates a block diagram of the wireless system implemented using a wireless local area network (e.g., WiFi), in accordance with certain embodiments of the disclosure.

FIG. 3 illustrates a block diagram of a 5G wireless system, in accordance with certain embodiments of the disclosure.

FIG. 4 illustrates a flow diagram of a method for wireless transmission of a video stream and control of machinery, in accordance with certain embodiments of the disclosure.

FIG. 5 illustrates a block diagram of a computing system, in accordance with certain embodiments of the disclosure.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### OVERVIEW

Various aspects of the disclosure are provided.

In one aspect, a method is provided for remotely viewing and/or operating machinery. The method includes acquiring a video stream from two or more cameras fixed to the machinery; transmitting, via a wired link, the video stream from the cameras to a first radio; transmitting, via a first wireless link, the video stream from the first radio; receiving, via a second wireless link, the video stream at a second radio; decoding the video stream to generate a video of a field of view of the two or more cameras; and controlling a display of a computer to display the generated video.

In a further aspect, the method may also include that the machinery is excavation equipment operated in an exclusion zone, which is a region within which workers are not permitted due to a hazardous condition within the exclusion zone.

In a further aspect, the method may also include receiving, via the first wireless link, the video stream at wireless repeater; and transmitting, via the second wireless link, the video stream from the wireless repeater to the second radio.

In a further aspect, the method may also include that the wireless repeater includes a third radio and a fourth radio. The method may also include receiving the video stream at the wireless repeater by receiving the video stream at the third radio from the first radio via the first wireless link; transmitting the video stream from the wireless repeater by transmitting the video stream from the fourth radio to the second radio via the second wireless link; and transmitting, via another wired link, the video stream from the third radio to the fourth radio.

In a further aspect, the method may also include that the first wireless link is on a different frequency channel than the second wireless link, and the first wireless link operates simultaneously with the second wireless link.

In a further aspect, the method may also include that the first wireless link is a point-to-multipoint link, and the second wireless link is a point-to-point link.

In a further aspect, the method may also include that the repeater uses a second omnidirectional antenna to receive the video stream via the first wireless link; the repeater uses a first directional antenna to transmit, via the second wireless link, the video stream to the second radio; and the second radio uses a second directional antenna to receive the video stream via the second wireless link.

In a further aspect, the method may also include receiving user inputs at the computer, the user inputs indicating an action to be performed by the machinery; generating control signals based on the user inputs; and transmitting the control signals via a wireless channel configured to transmit control signals that remotely control actions by the machinery.

In a further aspect, the method may also include determining a power spectral density near the repeater and selecting respective frequency bands for the first wireless link and the second wireless link that reduce noise or co-channel interference relative to non-selected frequency bands.

In a further aspect, the method may also include that respective frequency channels for the first wireless link and the second wireless link are selected to be in a range of about 5.5 GHz to about 6 GHz.

In a further aspect, the method may also include that the second radio is not within a line of sight of the first radio, and the repeater is within a line of sight of the first radio and is within a line of sight of the second radio.

In a second aspect, a system is provided for remotely controlling machinery. The system includes a camera fixed to the machinery, and the camera is configured to acquire a video stream of a field of view including a portion of the machinery; a first radio connected to the camera via a first wired link, and the first radio is configured to transmit the video stream via a first wireless link; a computer located at a control station and configured to decode the video stream to generate video and display the generated video on a display of the computer; and a second radio connected to a computer, and the second radio is configured to receive the video stream via a second wireless link.

In a further aspect, the system may also include that the machinery is excavation equipment operated in an exclusion zone, which is a region within which workers are not permitted due to a hazardous condition within the exclusion zone.

In a further aspect, the system may also include a wireless repeater configured to receive the video stream via the first wireless link, and transmit the video stream via the second wireless link.

In a further aspect, the system may also include that the wireless repeater comprises a third radio and a fourth radio and comprises another wired link that conveys the video stream from the third radio to the fourth radio, the third radio is configured to receive the video stream from the first radio via the first wireless link; and the fourth radio is configured to transmit the video stream to the second radio via the second wireless link.

In a further aspect, the system may also include that the first wireless link is on a different frequency channel than the second wireless link, and the first wireless link operates simultaneously with the second wireless link.

In a further aspect, the system may also include that the first wireless link is a point-to-multipoint link, and the second wireless link is a point-to-point link.

In a further aspect, the system may also include that the first radio uses a first omnidirectional antenna to transmit, via the first wireless link, the video stream to the repeater; the repeater uses a second omnidirectional antenna to receive the video stream via the first wireless link; the repeater uses a first directional antenna to transmit, via the second wireless link, the video stream to the second radio; and the second radio uses a second directional antenna to receive the video stream via the second wireless link.

In a further aspect, the system may also include an input device connected to the computer and configured to receive user inputs that indicate an action to be performed by the machinery, wherein the computer is configured to generate control signals based on the user inputs, and another radio is configured to transmit the control signals via a wireless channel that is configured to transmit control signals to the machinery.

In a further aspect, the system may also include that the repeater is configured to measure a power spectral density and then select, based on the measured power spectral density, respective frequency bands for the first wireless link and the second wireless link that reduce noise or co-channel interference relative to non-selected frequency bands.

In a further aspect, the system may also include that respective frequency bands for the first wireless link and the second wireless link are selected to be in a range of about 5.5 GHz to about 6 GHz.

In a further aspect, the system may also include that the second radio is arranged outside of a line of sight of the first radio, and the repeater is arranged to be within a line of sight of the first radio and within a line of sight of the second radio.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for low-latency, wireless video transmission from a work site that is in an exclusion zone to a control station that is outside the exclusion zone.

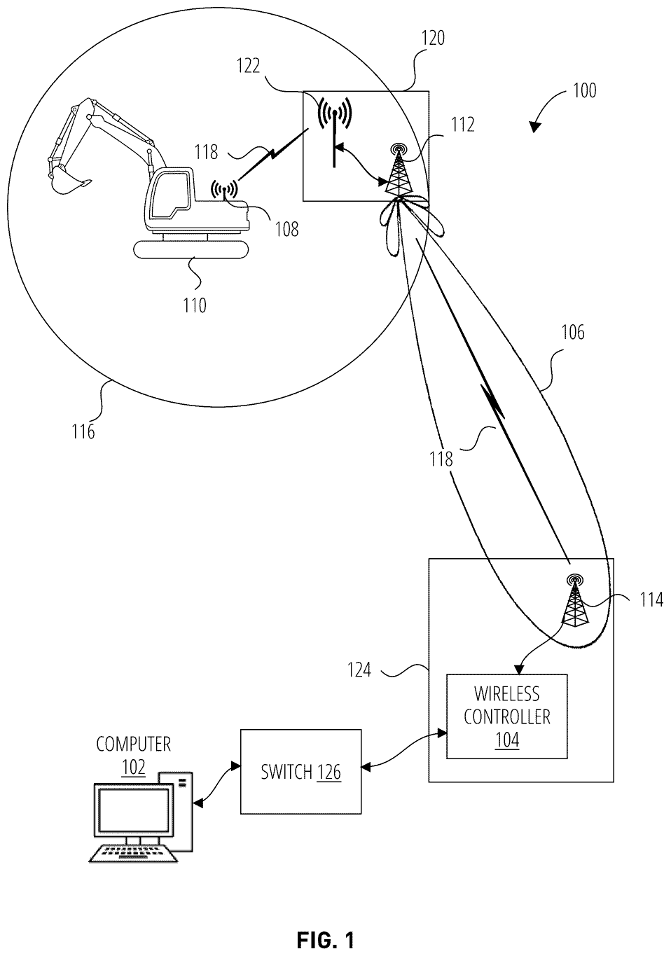

FIG. 1 illustrates a wireless system 100 for remotely controlling machinery 110 from a remote location. For example, machinery 110 can be an excavator that is being used to remove unexploded ordinance (UXO), and machinery 110 is being controlled from a control station (e.g. mobile office, vehicle, or CONNEX box). According to certain non-limiting examples, machinery 110 can be located in an undeveloped location that has limited communication infrastructure (e.g., a missile/bomb testing range). Further, the location of machinery 110 can be temporary, such that machinery 110 is moved frequently between locations within a given site, depending on where UXO is discovered.

When a large exclusion zone is required for removing the UXO, machinery 110 can be controlled remotely, to ensure the safety of the workers who remain outside the exclusion zone. Further, it can be more efficient to locate the control station at a single central site that is proximate to multiple locations of UXO (e.g., within a few miles). Thus, the control station can be moved once to the central site for multiple excavations of UXO.

Machinery 110 has a machinery radio 108 which receives via a wired link a stream of video data from camera devices that are fixed/arranged on machinery 110. The machinery radio 108 transmits the video stream to a repeater 120, which, according to certain non-limiting examples, can include a repeater radio 122 and first access point (AP1) 112. For example, the machinery radio 108 transmits the video stream via a direct wireless link 118 to the repeater radio 122 of the repeater 120, and, from the repeater radio 122, the video stream is transmitted via a wired link to AP1 112, which is part of the 124. AP1 112 then repeats the transmission of the video stream to a second access point (AP2) 114 also via a direct wireless link 118. AP2 114 is part of the control-station wireless system 124, which includes AP2 114 and a wireless controller 104. The video stream is then routed through a switch 126 to the computer 102.

According to certain non-limiting examples, the repeater radio 122 is located within the repeater 120 where a wired connection transmits the video data from the repeater radio 122 to AP1 112, which is a long-range point-to-point (PTP) radio that then transmits the video data stream via a direct wireless link 118 to AP2 114, which is also a long-range PTP radio. The video stream is then routed through the wireless controller 104 and the switch 126 to the computer 102.

Latency in the video stream from being acquired at machinery 110 to being displayed on the computer 102 can be detrimental because the user depends on the video stream to react to and control the operation/movements of machinery 110. The wireless system 100 can be optimized in several ways to minimize the latency. For example, the repeater radio 122 and AP1 112 can receive and transmit on separate channels such that receiving and transmitting can occur simultaneously and continuously without dividing time between receiving and transmitting. Further, there are several video compression options for transmitting data, and the selection of various video compression options can either increase or decrease the latency. For example, using the H.264 compression standard and using the full data rate available for the video stream can decrease the latency.

According to certain non-limiting examples, AP1 112 and AP2 114 can be long-range PTP radios that operate on a different frequency/channel than the frequency/channel of the machinery radio 108 and the repeater radio 122. That is, the long-range PTP radios operate on one channel/frequency and the machinery radio 108 is a shorter-range, omnidirectional, point-to-multipoint radio fixed to machinery 110 that uses a nonOverlaping channel/frequency to communicate with the repeater 120, thereby minimizing co-channel interference.

As illustrated in FIG. 1, an omnidirectional antenna pattern can be used for transmission and reception for the machinery radio 108, and an omnidirectional antenna pattern can be used for the receiving/transmitting antenna of the repeater radio 122. Because the machinery radio 108 is attached to machinery 110, the machinery radio 108 moves and rotates with machinery 110, such that a directional antenna for the machinery radio 108 would result in variations in the signal strength transmitted toward repeater 120. In contrast, using an omnidirectional antenna for the machinery radio 108 ensures that the signal strength for transmissions between the machinery radio 108 and repeater 120 remains within a desired range, regardless of the movements of machinery 110. However, the omnidirectional antenna can only transmit over shorter distances (e.g., distance of less than 0.5 miles) because the omnidirectional antenna lacks a significant antenna gain (e.g., an antenna gain of greater than 4 or greater than 10).

Generally, both the machinery radio 108 and repeater radio 122 use omnidirectional antennas to allow machinery 110 to move and change orientation with respect to the repeater 120 without affecting the communication signal strength.

Alternatively or additionally, the repeater 120 can use a sector antenna for the repeater radio 122. For example, if machinery 110 remains within a certain solid angle with respect to the repeater radio 122, then repeater radio 122 can use a sector antenna that has a directional antenna that spans the solid angle capturing all possible locations of machinery 110. For example, an antenna pattern of the repeater radio 122 that spans 90 degrees or 120 degrees may be sufficient to capture all possible locations of machinery 110.

To compensate for the limited transmission range of the 108, the repeater 120 receives the video stream and then AP1 112 retransmits the video stream using a direction antenna. FIG. 1 illustrates a first antenna pattern 116 for the machinery radio 108 and a second antenna pattern 106 for AP1 112. The first antenna pattern 116 is omnidirectional, and the second antenna pattern 106 is directional toward AP2 114. Consequently, the distance between AP1 112 and AP2 114 can be greater than a mile/kilometer (e.g., several miles/kilometers), whereas the distance between AP1 112 and the machinery radio 108 is maintained to be less than a mile/kilometer (e.g., about 0.25-0.5 miles/kilometers).

The configuration of the machinery radio 108, repeater 120, repeater radio 122, AP1 112, and AP2 114, which is shown in FIG. 1, also has the benefit that line of site transmission can be maintained between each pair of radios, even when there is not a line of site between the control station and machinery 110. For example, when machinery 110 is in a valley, repeater 120 can be located on a nearby hill that has a line of sight to both the machinery radio 108 and AP2. Further, when machinery 110 changes work locations, it can be easier to relocate repeater 120, than to relocate the control station.

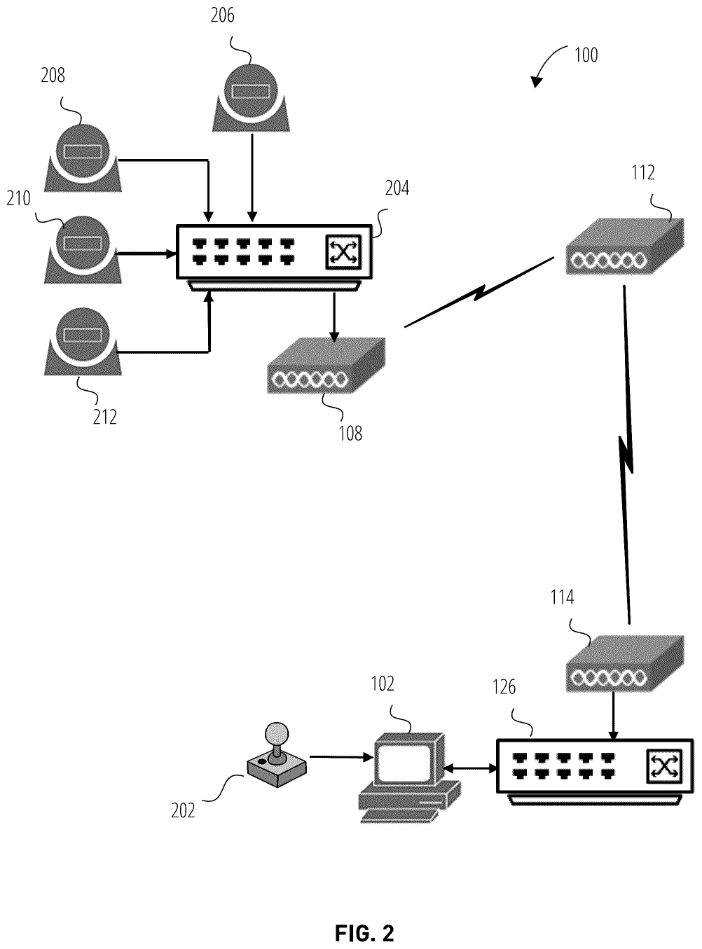

FIG. 2 illustrates a block diagram of a non-limiting example of wireless system 100 in which a WiFi or a wireless ethernet architecture is used for the wireless communications. In this example, the machinery radio 108, AP1 112, and AP2 114 are each illustrated as a WiFi/ethernet access points. In this non-limiting example, the repeater radio 122 has been consolidated into AP1 112, which is a WiFi/ethernet access point that has capabilities for simultaneously receiving and transmitting on different frequencies and channels. The machinery radio 108 is connected via a first switch 204 to four cameras (e.g., the first camera 206, second camera 208, third camera 210, and fourth camera 212). The first switch 204 can be, e.g., an eight-port, power over ethernet (PoE) switch. The cameras can provide different views. For example, the first camera 206 can provide a view of the inside of the cabin of machinery 110, and the second camera 208 a pan, zoom, tilt (PZT) camera outside the cabin. Further, the third camera 210 can be fixed to a boom or arm of an excavator to provide a closer view of a work area for machinery 110, and the fourth camera 212 can provide a rear view of machinery 110.

The machinery radio 108 can be a WiFi wireless station that is connected via a wired link to the first switch 204. AP1 112 can be a WiFi repeater that provides point-to-multipoint and/or point-to-point communications, such as a long-range wireless bridge. The transmit antenna attached to AP1 112 can be a directional antenna such as a phased array, a lensed horn feed, and/or a parabolic reflector antenna. AP1 112 can include two radios operating on different channels, with one channel being for receiving and another for transmitting. For example, one channel can be in the 2.4 GHz frequency band and the other channel can be in the 5 GHz frequency band. Alternatively, both channels can operate at different frequencies within the 5.8 GHz frequency band. Multiple frequency channels can be within each of these frequency bands, and the choice of which frequency channel within a given frequency band can be based on a measurement of the power spectral density within the given frequency band to identify which channels have the lowest noise and interference from other signals.

The video stream received by AP1 112 is then retransmitted to AP2 114, which then transmits the video stream via a wired link through the second switch 214 to the computer 102. The computer 102 can have various peripheral devices to display the video stream and to receive user inputs. The peripheral devices are illustrated in FIG. 2 using the non-limiting example of an input device 202, which can be a joystick, e.g., to remotely control machinery 110. Other examples of peripheral devices can include a mouse, a PTZ camera controller, a trackball, a touchpad, and a keyboard.

According to certain non-limiting examples, the wireless system 100 is provided on a former bombing range to remove UXO, and there is an exclusion zone within which workers are not permitted. For example, workers are required to remain outside of a certain radius from where digging occurs to remove the UXO (i.e., the exclusion zones). A solution to the exclusion zone is to remove the UXO using excavator equipment that is operated remotely. The camera system can be used to observe the operation of the excavator equipment from the safety of a control station. According to certain non-limiting examples, the control station can be in CONEX box that is armored and that is within a certain range of the UXO. However, the use of wireless communications allows the control station to be positioned outside the exclusion zone, in which case the additional safety is not required of placing the control station in CONEX box. The wireless system 100 provides transmissions from the camera system to the computer 102 in the control station. Further, the wireless system 100 can provide low latency, good connectivity, and line-of-sight transmission. For example, the connectivity is enhanced by using a directional radio antenna for AP1, and this also enables the operators to be further away thereby providing enhanced safety, comfort, and not needing to be in an armored CONEX box.

According to certain non-limiting examples, the camera system can be a point-to-multipoint camera network with, e.g., five cameras on each machine, and each machine is going to send that information/video stream back to where the operators are working. At a given site, there could be multiple machines, all sending their own video streams back to the computer(s) in the control station

According to certain non-limiting examples, the 100 includes a repeater (e.g., AP1 112) near where the machines are operating, and the repeater transmits the video stream back to the control station using a single directional antenna. The distance between machinery 110 and the control station can be several miles. Further, the longer range enabled by using a directional antenna can enable the control station to be located in a more comfortable environment for the operators/workers, and the control station can be outside the visual line of sight of machinery 110 because the repeater enables transmitting the video stream around corners and over hills, for example.

According to certain non-limiting examples, input devices 202 (e.g., controllers) can be provided for two or more different machines/equipment (e.g., one controller for an excavator and another controller for a haul truck). The control signals can be transmitted on a different frequency band or the same frequency band as one or both of the direct wireless links 118 for the video stream. For example, the video stream can be on a 5.8 GHz frequency band and the control signals can be transmitted using a 2.4 GHz frequency band, or the video stream and the control signals can both be on the 5.8 GHz frequency band. A given frequency band can have multiple channels, and the control signals can be transmitted on a different channel or the same channel as the video stream.

The input device 202 can be used to control a module on an excavator or a haul truck that actuates the hydraulics to operate the machine. The control signals for the hydraulics can be generated, processed, and used independently/separately from the camera technology. Further, the control signals can be transmitted independently/separately from the camera system. Cameras for respective machines can be displayed through different computers (e.g., one or more computers per machine). Due to the large amount of data in the video streams, a significant amount of computing power is used to process the video stream and then to display the resulting video images on one or more screens. Based on operator preferences, the video from multiple cameras can be displayed on the same screen, or the video stream for each of the cameras may be displayed on its own screen. Displaying the video stream on multiple screens can consume increased computation resources, which can be accommodated by using multiple processors and or graphics cards with graphic processing units (GPUs). The display images based on the video stream can be displayed on the monitor(s) of computer 102 using software for rendering images based on the video stream. The cameras can be powered over ethernet (e.g., the Ethernet cable provides both power and a wired data link).

Each access point and radio shown in FIG. 1 and FIG. 2 can actually include multiple radios (e.g., one or more radios operating at 2.4 GHz, one or more radios operating at 5 GHz, and one or more radios operating at 6 GHz). Further, each illustrated access point and radio generates one or more radio frequency (RF), microwave, millimeter wave, or GHz signals that drives a current in an antenna, resulting in the transmission of electromagnetic radiation in the RF, microwave, or millimeter wave spectrum. Further, the radios can operate at 5.8 GHz frequency, which has been demonstrated to provide high-quality transmission for video data. The antenna used on machinery 110 for the machinery radio 108 can be an omnidirectional antenna, allowing for like 3600 transmission. Therefore, machinery 110 can spin around it can drive wherever it needs to drive within a certain range without losing the signal. Omnidirectional antennas have less range than directional antennas. To get the signal the longer distance from the work site to the control station, a repeater (e.g., AP1 112) that has a directional antenna is used. The repeater could be omitted if the control station is close (e.g., about 500 yards away) to the work site and there is a line of sight between AP2 114 and the machinery radio 108.

According to certain non-limiting examples, a sector antenna can be used when machinery 110 remains within a known, limited area. For example, when machinery 110 is a haul truck that is traveling long distances, the antenna can be chosen to have a direction that captures the range of locations for machinery 110. For example, if machinery 110 moves to locations all the way around the control station, then the antenna for AP2 114 can be selected to be an omnidirectional antenna. If machinery 110 only moves in an area that is within a certain degree range, then the antenna for AP2 114 can be selected to be a sector antenna, which captures the range of where machinery 110 is moving.

According to certain non-limiting examples, the repeater (e.g., the combination of the repeater radio 122 and AP1 112) is used to allow larger distances between the control station and machinery 110 and to allow greater flexibility in the configuration of the wireless system 100. The repeater can be as close as reasonable to the operation of machinery 110, as long as the repeater maintains a line of sight with the control station. Transmissions from the repeater 120 to the machinery radio 108 (and receiving from the machinery radio 108 to the repeater 120) can be performed using omnidirectional antennas to ensure that wherever machinery 110 moves communications can be maintained. Omnidirectional antennas are used for both transmit and receive functions on the machinery radio 108, thereby maintaining communications and allowing for maximum flexibility for the movements of machinery 110.

When machinery 110 only moves in an area that falls within a limited range of angles from the repeater 120, then the antenna for the repeater radio 122 can be a sector antenna, which captures the limited range of angles within which the machinery's movements are constrained.

In contrast, a directional antenna is used for communications between the AP1 112 of the repeater 120 and AP2 114 of the control-station wireless system 124 because the locations and orientations of AP1 112 and AP2 114 can be fixed. Using directional antennas provides improved connectivity over longer distances due to the antenna gain provided by the directional antennas.

The latency in the wireless system 100 can depend on various factors, including, e.g., the camera settings. The camera settings can include the choice of codec, frame rate, and resolution. For example, through experimentation, it has been demonstrated that latency can be reduced by using the H.264 codec, setting the resolution to 1080p, setting the frame rate to 30 FPS, and setting the cameras to transmit at the highest bit rate in their settings, which can be counterintuitive. Setting the camera at the highest bit rate can improve latency by reducing the in-camera processing needed before the video data is available. Further, sending at the highest data rate does not generally present a challenge because the transmission system can generally be configured to have sufficient bandwidth to accommodate the data throughput. Further, latency can be improved by, in the settings for the cameras, turning off watermark features and turning off smart codec features.

Sending at the highest bandwidth can improve latency by reducing the number of processing steps before sending the video stream, and, generally sending at the highest data rate is not challenging because the transmission system is not bandwidth limited. Further, latency can be improved by, in the settings for the cameras, turning off watermark features and turning off smart codec features.

According to certain non-limiting examples, the parameters of the wireless transmission can be optimized to improve the performance of the transfer of data. For example, the parameter can be chosen to improve channel capacity, reduce noise and/or co-channel interference, increase signal-to-noise ratio, and/or decrease attenuation. For example, it has been demonstrated that, for the transmission of video data, higher frequency bands can provide better performance than lower frequency bands. Further, when using a point-to-multipoint mode of operation, different frequencies and channels can be used to avoid co-channel interference. The different channels can also be spaced apart in frequency to avoid bleeding over from one channel to the other.

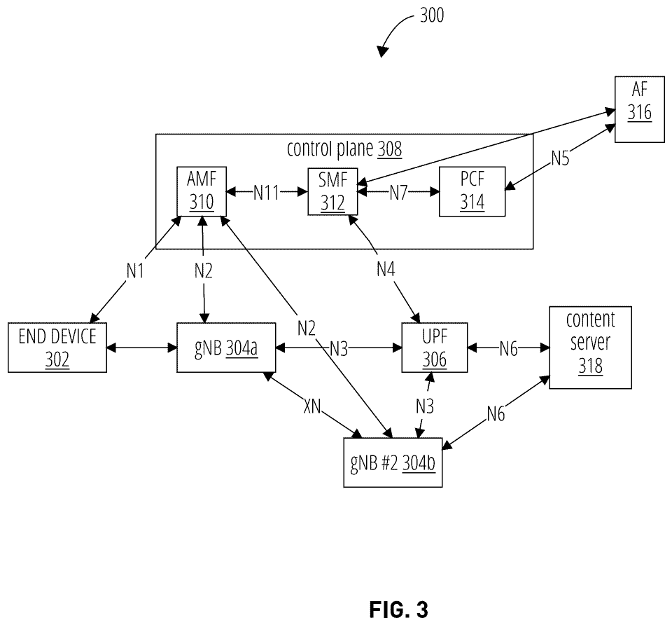

Each leg in the transmission/reception path can effectively be operated as its own network. For example, one leg is the transmission from AP1 112 (i.e., at the repeater 120) to AP2 114 (i.e., at the control-station wireless system 124 station), and a second leg is the transmission from the machinery radio 108 to the repeater radio 122. So the two legs can be viewed as two different wireless networks that are connected at the repeater 120. The repeater 120 can function as a wired link between these two wireless transmission legs. The wireless leg from the machinery radio 108 to the repeater radio 122 can be a point-to-multipoint wireless network, and the wireless leg from AP1 112 to AP2 114 can be a point-to-point wireless network.

Whereas FIG. 2 illustrates using a WiFi wireless network to implement remote transmission of a video stream and control of machinery 110, a person of ordinary skill in the art would understand that other wireless networks can be used. For example, FIG. 3 illustrates another non-limiting example of using a network 300, which can be a 5G network or another similar network. In this example, the AP1 112 can be implemented via gNB 304a and AP2 114 can be implemented via gNB #2 304b, and these communication directly with each other via the connection Xn. The machinery radio 108 an be implemented via the end device 302. And the computer 102 can be connected via an application connected to content server 318 (e.g., the internet). For example, the computer 102 can be any location that has access to the internet.

The network 300 includes an end device 302, a next generation NodeB (gNB) 304a, a user plane function (UPF) 306, a control plane 308 (which includes an access and mobility management function (AMF) 310, a session management function (SMF) 312, a policy control function (PCF) 314), an application function (AF) 316, and a content server 318.

According to certain non-limiting examples, embodiments, and implementations, the network 300 can be a 5G wireless network 300 in which embodiments presented herein may be implemented. The network 300 may include a number of network nodes and/or entities, such as end device 302, e.g., a mobile telephone. The network 300 may be, For example, an enterprise private Third Generation Partnership project (3GPP) based network, such as a private Fifth Generation (5G) network for “private 5G.” Such enterprise deployments may have mission-critical devices, Internet of Things (IoT) devices, and/or robotics devices, where application-specific Quality of Service (QoS) treatment, low latency, and reliability are key considerations.

It will be appreciated that network 300 can include multiple end devices; however, one end device is depicted for simplicity. The end device 302 may be any suitable type of device, such as a tablet device, an IoT device, a Machine-to-Machine (M2M) device, a robotics device, and a sensor, etc. end device 302 may obtain access to the private 5G network via one or more base stations, such as a gNB 304a.

In the non-limiting example in FIG. 3, the network 300 is illustrated with the gNB 304a being a next generation NodeB (gNB), but it is understood that, instead of using a gNB as the radio access network (RAN), the network 300 may be implemented using, as an RAN, one or more of an evolved universal mobile telecommunications system (UMTS) terrestrial radio gNB (E-UTRAN), a radio area network, and/or a next generation radio area network (NG-RAN) (each more generally referred to as a “RAN”). The gNB 304a may include one or more eNodeB (eNB) entities and/or one or more next generation NodeB (gNB) devices. The eNB and gNB entities (more generally referred to as a “gNB”) may communicate with one another via one or more X2 (referred to as “Xn” in 5G) interfaces. For example, as illustrated in FIG. 3, gNB #2 304b is connected to gNB 304a via an Xn interface.

In the data plane, network 300 also includes UPF 306 and content server 318. As discussed in more detail below, the data plane supports various methods for sending protocol data units (PDUs) from content server 318 to end device 302.

In addition to the data plane of network 300 over which flows of traffic are conveyed between end device 302 to content server 318, network 300 also includes a control plane 108 to manage/control the data plane. The network 300 may include one or more local area networks (LANs) and one or more wide area networks (WANs), such as the Internet.

Control planes of a control plane 308 may be utilized in network 300 for access and mobility management, session management, and/or policy management and control for end device 302. In particular, the control plane 308 may include an Access and Mobility Management Function (AMF) 310 and a Session Management Function (SMF) 312. The AMF 310 and SMF 312 may be implemented as separate functions or components, or alter-natively provided together as an integrated functionality (in whole or in part) and/or co-located at the same node or component. A protocol data unit (PDU) session at UPF 306 may be managed by SMF 312 over an N4 interface using a Packet Forwarding Control Protocol (PFCP), for example. In some implementations, control plane 308 is provided locally in the network 300. In other implementations, control plane 308 is provided as part of a cloud infrastructure. In some implementations, the private 5G network may be configured without use of a Policy and Control Function (PCF) 314.

End device 302 may communicate with access and mobility management function (AMF) 310 via the gNB 304a. AMF 310 may communicate control signaling (e.g., non-access stratum (NAS) signaling) with end device 302 using an N1 interface. AMF 310 may communicate control signaling with the gNB using an N2 interface. AMF 310 may facilitate communication by other network functions with end device 302 and/or the gNB 304a. For example, other network functions may subscribe to notifications regarding mobility events relating to end device 302. AMF 310 may support termination of non-access stratum (NAS) signaling, NAS ciphering and integrity protection, registration management, connection management, and/or mobility management. AMF 310 may support access, authentication, and authorization (AAA) and/or security context management.

AMF 310 may communicate control signaling with a session management function (SMF) 312 using an N11 interface. SMF 312 may support session establish-ment, modification, and/or release. SMF 312 may allocate and manage the allocation of an internet protocol (IP) address to end device 302. SMF 312 may support dynamic host configuration protocol (DHCP) functions. SMF 312 may support termination of NAS signaling related to session management. SMF 312 may support traffic steering configuration for one or more user plane functions (UPFs) 306. When multiple AMFs are present, they may communicate with each other over one or more N14 interfaces.

UPF 306 may communicate control signaling with the SMF 312 using an N4 interface. If multiple UPF entities are present, they may communicate control signaling with each other using one or more N9 interfaces. UPF 306 may communicate data signaling with the gNB 304a using an N3 interface. UPF 306 may support packet routing and forwarding, packet inspection, and handing of quality of service (QoS). UPF 306 may act as an external protocol data unit (PDU) session point of interconnect to a content server 318, such as the Internet. UPF 306 may communicate data signaling with the content server 318 using an N6 interface. UPF 306 may serve as an anchor point for mobility within and between radio access technologies (RATs).

A policy control function (PCF) 314 may communicate control signaling with the SMF 312 using an N7 interface. PCF 314 may communicate control signaling with the AMF 310 using an N15 interface. PCF 314 may provide policy rules to other control plane entities. PCF 314 may provide access-subscription information for policy decisions in a unified data repository, for example.

An application function (AF) 316 may communicate control signaling with the PCF 314 using an N5 interface. The AF 316 may support application influence on traffic routing. The AF 316 may interact with PCF 314 to provide policy control. In the ensuing description, control signaling, data signal, and NAS signaling may be referred to more generally as “signaling.”

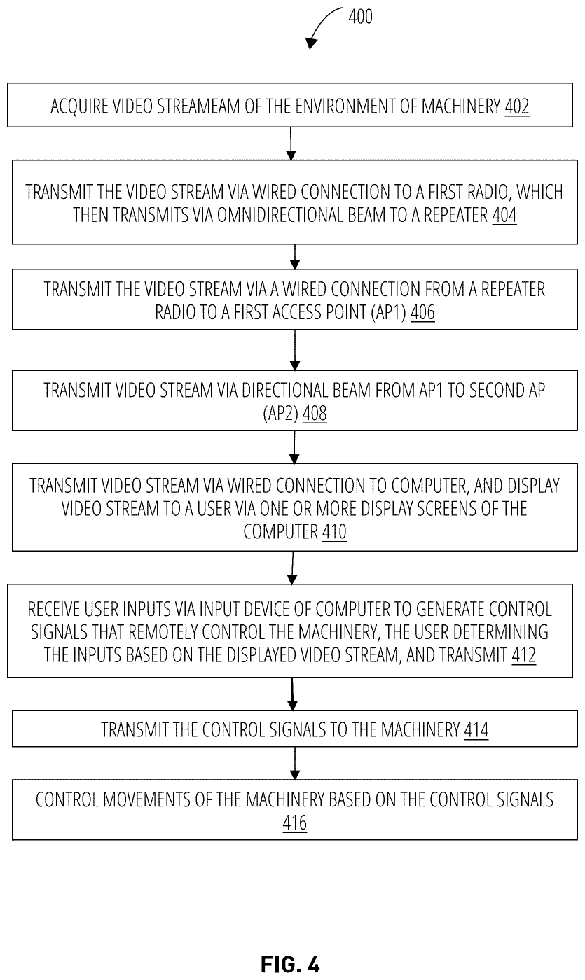

FIG. 4 illustrates an example method 400 for using a wireless network to implement remote transmission of a video stream and control of machinery 110. For example, method 400 provides users in a control station the ability to remotely perform the following actions: (i) view the video captured by the passive cameras (e.g., cameras without pan tilt zoom (PTZ) functionality) that are fixed to the machinery; (ii) view the video captured by PTZ camera and control the PTZ functions thereof; and (iii) send control signals to control the movements of the machinery.

Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, at step 402, the method includes acquiring a video stream of the environment of machinery. Step 402 can be performed in accordance with the above disclosure referencing FIG. 1 and FIG. 2.

According to some examples, at step 404, the method includes transmitting the video stream via a wired link to a first radio, which then transmits the video stream via an omnidirectional beam to a first access point (AP1). Step 404 can be performed in accordance with the above disclosure referencing FIG. 1 and FIG. 2.

According to some examples, in step 406, the repeater radio 122 transmits the video stream to the first access point (AP1) 112 via a wired connection. Step 406 can be performed in accordance with the above disclosure referencing FIG. 1 and FIG. 2.

According to some examples, in step 408, AP1 transmits the video stream to a second AP (AP2) via a directional beam. Step 408 can be performed in accordance with the above disclosure referencing FIG. 1 and FIG. 2.

According to some examples, at step 410, the method includes transmitting video stream via wired link to a computer and displaying video stream to a user via one or more display screens of one or more computers. Step 410 can be performed in accordance with the above disclosure referencing FIG. 1 and FIG. 2.

According to some examples, at step 412, the method includes receiving user inputs via an input device of the one or more computers to generate control signals that remotely control the machinery. The user determines the inputs based on the displayed video stream.

Step 412 can be performed in accordance with the above disclosure referencing FIG. 1 and FIG. 2.

According to some examples, step 414 of the method includes transmitting the control signals to the machinery. Step 414 can be performed in accordance with the above disclosure referencing FIG. 1 and FIG. 2.

According to some examples, step 416 of the method includes controlling the movements of the machinery based on the control signals. Step 416 can be performed in accordance with the above disclosure referencing FIG. 1 and FIG. 2.

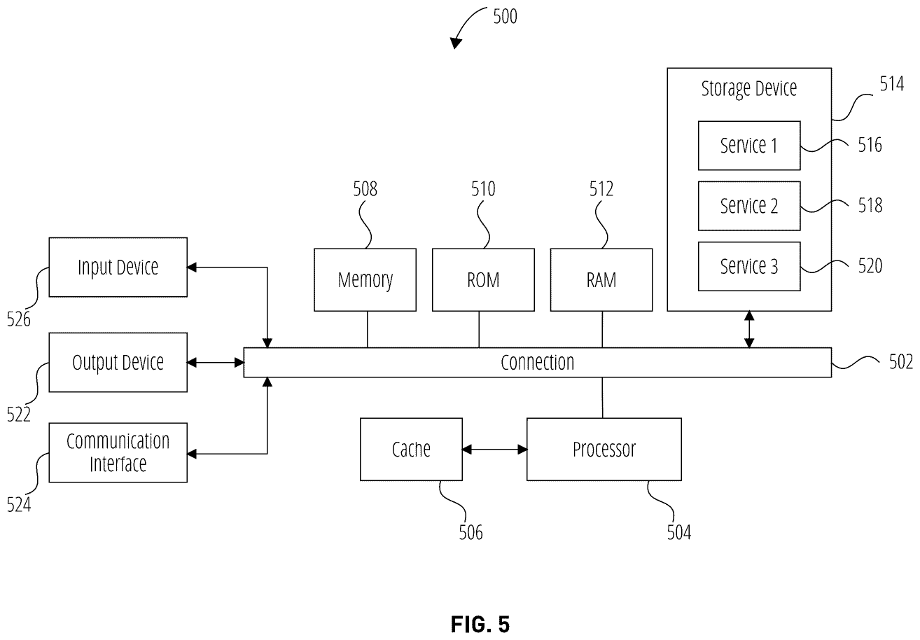

FIG. 5 shows an example of computing system 500, which can be for example any computing device making up the computer 102, machinery radio 108, the repeater radio 122, the repeater 120, AP1 112, AP2 114, or one of the cameras (e.g., first camera 206, second camera 208, third camera 210, or fourth camera 212), or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) processor 504 and connection 502 that couples various system components including system memory 508, such as read-only memory (ROM) 510 and random access memory (RAM) 512 to processor 504. Computing system 500 can include a cache of high-speed memory cache 506 connected directly with, in close proximity to, or integrated as part of processor 504.

Processor 504 can include any general-purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., such that when the code that defines such software is executed by the processor 504, it causes the system to perform a function. In some embodiments, a hardware service that performs a particular function can include the software component stored in a computer-readable medium in connection with the necessary hardware components, such as processor 504, connection 502 output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a network devices and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, e.g., instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for remotely viewing and/or operating machinery, the method comprising:
acquiring a video stream from two or more cameras fixed to the machinery;
transmitting, via a wired link, the video stream from the cameras to a first radio;
transmitting, via a first wireless link, the video stream from the first radio;
receiving, via a second wireless link, the video stream at a second radio;
decoding the video stream to generate a video of a field of view of the two or more cameras; and
controlling one or more displays of one or more computers to display the generated video.

2. The method of claim 1, wherein the machinery is excavation equipment operated in an exclusion zone, which is a region within which workers are not permitted due to a hazardous condition within the exclusion zone.

3. The method of claim 1, further comprising:
receiving, via the first wireless link, the video stream at wireless repeater; and
transmitting, via the second wireless link, the video stream from the wireless repeater to the second radio.

4. The method of claim 3, wherein:
the wireless repeater includes a third radio and a fourth radio; and
the method further comprises
receiving the video stream at the wireless repeater by receiving the video stream at the third radio from the first radio via the first wireless link;
transmitting the video stream from the wireless repeater by transmitting the video stream from the fourth radio to the second radio via the second wireless link; and
transmitting, via another wired link, the video stream from the third radio to the fourth radio.

5. The method of claim 1, wherein:
the first wireless link is on a different frequency channel than the second wireless link, and
the first wireless link operates simultaneously with the second wireless link.

6. The method of claim 1, wherein
the first wireless link is a point-to-multipoint link, and
the second wireless link is a point-to-point link.

7. The method of claim 3, wherein
the first radio uses a first omnidirectional antenna to transmit, via the first wireless link, the video stream to the repeater;
the repeater uses a second omnidirectional antenna to receive the video stream via the first wireless link;
the repeater uses a first directional antenna to transmit, via the second wireless link, the video stream to the second radio; and
the second radio uses a second directional antenna to receive the video stream via the second wireless link.

8. The method of claim 1, further comprising:
receiving user inputs at the computer, the user inputs indicating an action to be performed by the machinery;
generating control signals based on the user inputs; and
transmitting the control signals via a wireless channel configured to transmit control signals that remotely control actions by the machinery.

9. The further of claim 3, further comprising:
determining a power spectral density near the repeater and selecting respective frequency bands for the first wireless link and the second wireless link that reduce noise or co-channel interference relative to non-selected frequency bands.

10. The further of claim 3, wherein respective frequency bands for the first wireless link and the second wireless link are selected to be in a range of about 5.5 GHz to about 6 GHz.

11. The further of claim 3, wherein
the second radio is not within a line of sight of the first radio, and
the repeater is within a line of sight of the first radio and is within a line of sight of the second radio.

12. A system for remotely viewing and/or operating machinery, the system comprising:
a camera fixed to the machinery, and the camera being configured to acquire a video stream of a field of view including a portion of the machinery;
a first radio connected to the camera via a first wired link, and the first radio is configured to transmit the video stream via a first wireless link;
a computer located at a control station and configured to decode the video stream to generate video and display the generated video on a display of the computer; and
a second radio connected to a computer, and the second radio is configured to receive the video stream via a second wireless link, wherein
the control station is located outside the exclusion zone, which is a region within which workers are not permitted due to a hazardous condition within the exclusion zone.

13. The system of claim 12, wherein the machinery is excavation equipment operated in an exclusion zone, which is a region within which workers are not permitted due to a hazardous condition within the exclusion zone.

14. The system of claim 12, further comprising:
a wireless repeater configured to receive the video stream via the first wireless link, and transmit the video stream via the second wireless link.

15. The system of claim 14, wherein
the wireless repeater comprises a third radio and a fourth radio and comprises another wired link that conveys the video stream from the third radio to the fourth radio,
the third radio is configured to receive the video stream from the first radio via the first wireless link; and
the fourth radio is configured to transmit the video stream to the second radio via the second wireless link.

16. The system of claim 12, wherein:
the first wireless link is on a different frequency channel than the second wireless link, and
the first wireless link operates simultaneously with the second wireless link.

17. The system of claim 12, wherein
the first wireless link is a point-to-multipoint link, and
the second wireless link is a point-to-point link.

18. The system of claim 14, wherein
the first radio uses a first omnidirectional antenna to transmit, via the first wireless link, the video stream to the repeater;
the repeater uses a second omnidirectional antenna to receive the video stream via the first wireless link;
the repeater uses a first directional antenna to transmit, via the second wireless link, the video stream to the second radio; and
the second radio uses a second directional antenna to receive the video stream via the second wireless link.

19. The system of claim 14, further comprising:
an input device connected to the computer and configured to receive user inputs that indicate an action to be performed by the machinery, wherein
the computer is configured to generate control signals based on the user inputs, and
another radio is configured to transmit the control signals via a wireless channel that is configured to transmit control signals to the machinery.

20. The system of claim 14, wherein
the repeater is configured to measure a power spectral density and then select, based on the measured power spectral density, respective frequency bands for the first wireless link and the second wireless link that reduce noise or co-channel interference relative to non-selected frequency bands.

21. The system of claim 14, wherein respective frequency bands for the first wireless link and the second wireless link are selected to be in a range of about 5.5 GHz to about 6 GHz.

22. The system of claim 14, wherein
the second radio is arranged outside of a line of sight of the first radio, and
the repeater is arranged to be within a line of sight of the first radio and within a line of sight of the second radio.
